(19) United States
(12) Patent Application Publication
(10) Pub. No.: US 2007/0049176 A1
(43) Pub. Date: Mar. 1, 2007

(54) POWERED PAINT PREPARATION KIT AND METHOD

(75) Inventor: Michael B. Jones, Excelsior, MN (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: WAGNER SPRAY TECH CORPORATION, Plymouth, MN (US)

(21) Appl. No.: 11/553,833

(22) Filed: Oct. 27, 2006

Related U.S. Application Data
(62) Division of application No. 10/870,793, filed on Jun. 17, 2004, now abandoned.

(51) Int. Cl. B24B 1/00; B08B 7/00; B08B 3/00; B24B 27/08; C23D 17/00

(52) U.S. Cl. 451/28; 134/26; 134/6; 134/38; 15/28; 451/359

(57) ABSTRACT

A paint preparation tool, kit and method for preparing a previously coated surface by optionally mechanically removing loose coating material separated from the surface, applying a softening chemical to soften margin areas of the previously applied coating, and using a powered tool to rotate an abrasive disk against the surface to remove debris, dirt and oxides and to feather the edges of the remaining previously applied coating, where the abrasive disk may have a plurality of abrasive-impregnated elastomeric fingers extending generally perpendicularly from a disk-shaped support surface of the disk.

### CROSS REFERENCE TO RELATED APPLICATION

This application is a division of application Ser. No. 10/870,793 filed Jun. 17, 2004, the entire contents of which are hereby incorporated by reference.

### BACKGROUND OF THE INVENTION

A number of approaches to preparing previously coated surfaces for painting or staining are known. Typically paint is the coating to be removed, and as used herein, “paint” is to be understood to refer to any coating similar or identical to paint to be addressed in the process of preparing a surface for recoating, again typically using paint. Specifically, one other coating included within the meaning of “paint” as used herein is stain.

Among the prior art paint removal approaches are powered devices such as a heat gun (for use with a putty knife or scraper), an infrared heat source sold under the name “Silent Paint Remover,” a rotary cutter sold under the name “Paint Shaver,” a rotary grinder sold under the name “Power Paint Remover.” In addition to powered products, manual products and processes have been known, such as carbide scrapers, chemical paint strippers, powered washers using a water stream of 1500 to 4000 psi at 2 to 4 GPM (with pressures at about 4000 psi needed to remove paint), and various sanding appliances, wire brushes and other such abrasives. As is also known, each of these prior art approaches have various shortcomings, including substantial manual effort, operator skill, potential damage to the substrate from which the paint is to be removed, and time.

The present invention overcomes shortcomings of the prior art by providing an apparatus, kit and method that is easy, fast, convenient and economical to use.

### BRIEF DESCRIPTION OF THE DRAWINGS

FIG. 1 is a perspective view of a paint preparation tool useful in the practice of the present invention.

FIG. 2 is an alternative embodiment of the tool of FIG. 1.

FIG. 3 is a view similar to that of FIG. 2, except showing a user's hand grasping the tool.

FIG. 4 is a view of a kit including the tool of FIG. 1, along with a paint softening chemical and applicator in the form of a paint brush.

FIG. 5 is an alternative embodiment for the kit of FIG. 4 with the paint softening chemical applicator in the form of a sprayer.

FIG. 6 is a section view taken along line VI-VI of FIG. 2, showing various internal details of the paint preparation tool of the present invention.

FIG. 7 is an exploded view of an assembly of a bristle disk, backing disk and attachment nut useful with the paint preparation tool of the present invention.

FIG. 8 is a plan view of a front or bristle side of a bristle disk useful in the practice of the present invention.

FIG. 9 is a section view of a surface in need of repainting, with paint chipped and peeling from the surface.

FIG. 10 is a view of the surface of FIG. 9, except after mechanical removal of loose paint.

FIG. 11 is a view of the surface of FIG. 10, except after application of a paint softening chemical.

FIG. 12 is a view of the surface of FIG. 11, except after treatment according to the present invention and with the surface ready for repainting.

### DETAILED DESCRIPTION OF THE INVENTION

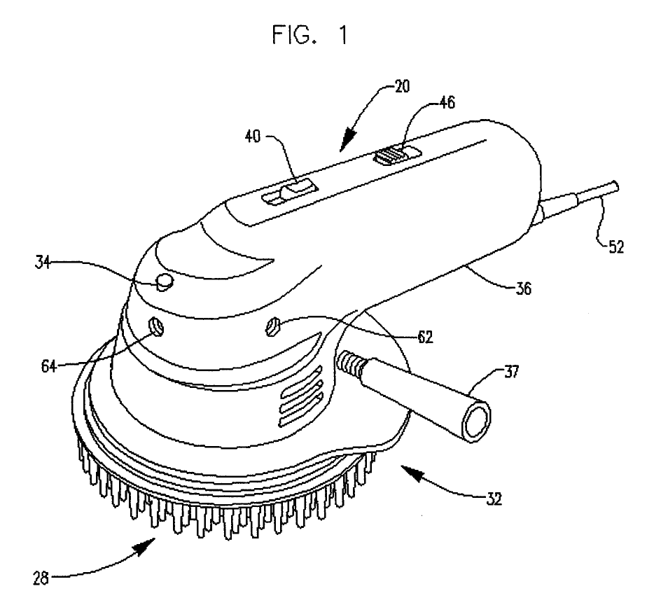

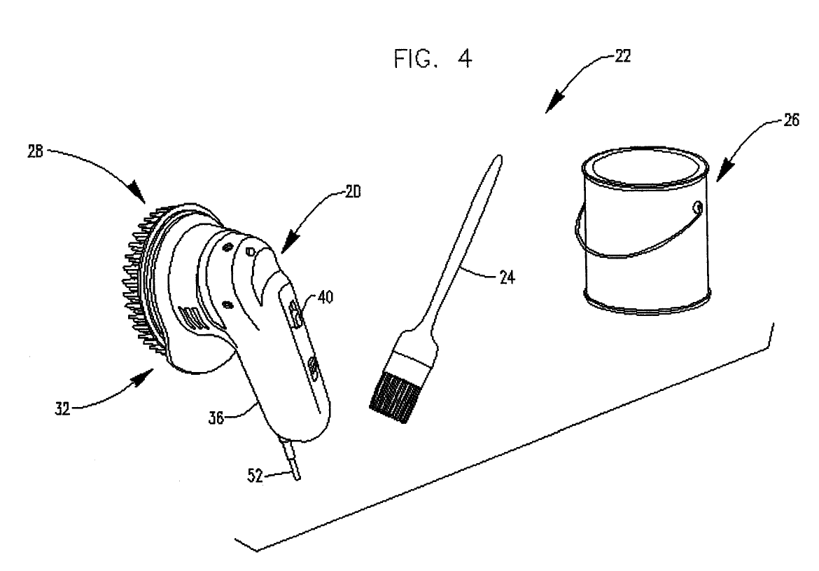

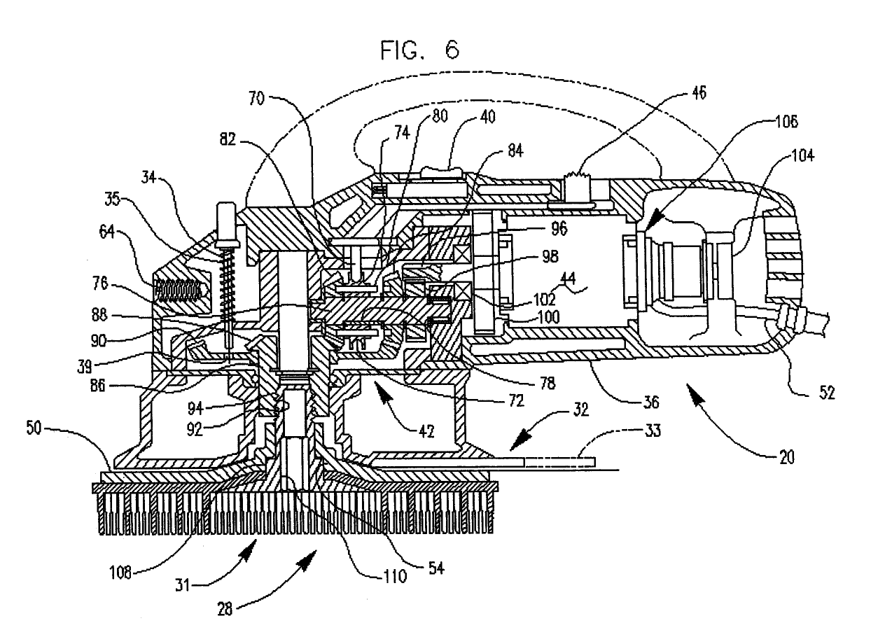

Referring to the Figures, and most particularly to FIGS. 1 and 4, the present invention includes a powered surface preparation tool 20 and kit 22 including the tool 20, a conventional paint brush 24, and a paint softening chemical 26. In the preferred practice of the present invention, the brush 24 is used to apply the chemical 26 and the tool 20 is used to remove paint oxides and loose paint and feather the edges between bare substrate and well-secured old paint on the substrate. As used herein “substrate” refers to the surface previously coated or to be coated with paint or a similar protective coating material. An optional pre-treatment step is to remove loose peeling and chipped paint with a conventional putty knife or paint scraper. The tool 20 is preferably electrically powered, and utilizes an abrasive disk 28, which may be similar to a bristle disc available from the 3M Industrial Business, 900 Bush Avenue, St. Paul, Minn. 55106, as a 4.5″ or 6″ bristle disc, UPC No. 24241-5 or 27675-4, except that the preferred bristle disk has a slightly softer elastomer composition and a special hub or mounting arrangement 30 specific to the tool 20. Bristle discs which are the same or similar to disk 28 are described in U.S. Pat. No. 5,983,434, the entire contents of which are incorporated herein by reference. In the embodiment (shown in FIGS. 6-8) disk 28 has a non-circular shaped aperture 30 and a specially configured mounting nut 31 to provide that the disk 28 is only used with the tool 20. The tool 20 preferably operates the disk at a maximum speed of about 3000 RPM, with about 10 in-lb of torque when loaded against a surface to be treated. Optionally, a second, slower speed of about 1500 RPM may be made available in the tool 20.

Tool 20 has a guard 32 in the form of a curved flange (which may be extended further under a handle 36 if desired in an alternative embodiment, as indicated by chain line 33) to shield a hand of the operator grasping the tool by the handle 36 from contact with the disk 28. In operation, the tool 20 is moved adjacent the surface to be treated, and bristles 38 of disk 28 are deformed by manual pressure of the tool 20 against the surface to be treated. Tool 20 also preferably has an ON-OFF switch 40 to energize the tool, rotating the disk 28 when the switch 40 is moved to the ON position.

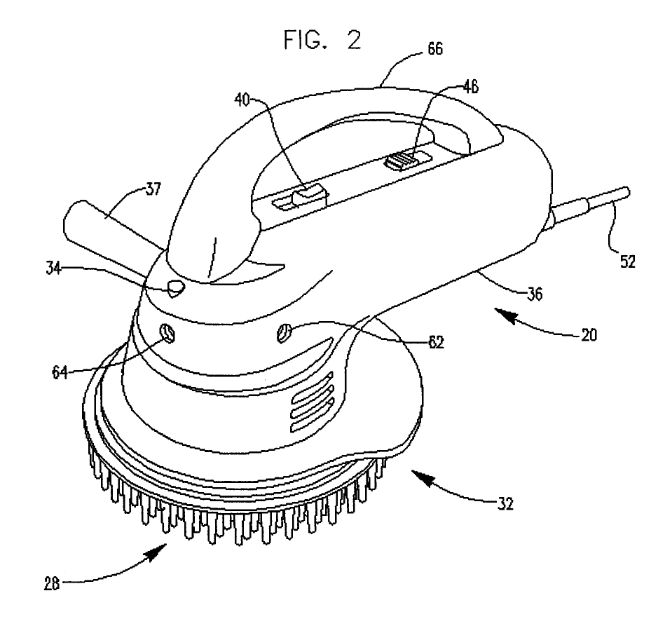

Tool 20 may optionally have an auxiliary handle 37 to allow two-handed operation. Auxiliary handle may be attached to tool 20 in a left-hand threaded recess 62 (shown in FIG. 1), or a corresponding right hand threaded recess (as shown in FIG. 2) or, optionally, there may be an inline threaded recess 64 for attachment of auxiliary handle 37 in line with main handle 36.

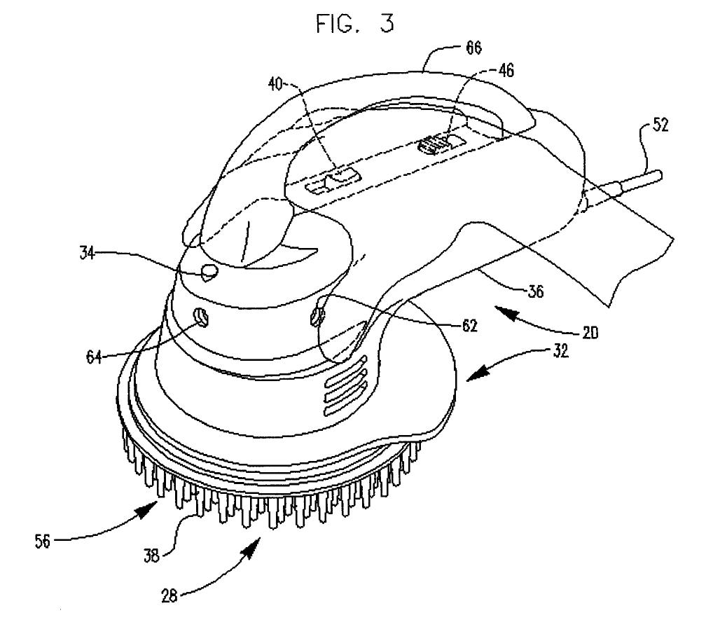

In an alternative embodiment shown in FIGS. 2 and 3, tool 20 may optionally include a strap or arch 66 to assist a user in holding the tool, as is illustrated in FIG. 3. Arch 66 may be permanently or removably secured to the tool using conventional techniques.

Referring now also to FIG. 6, tool 20 also has a right angle gear drive 42 driven by an electric motor 44, which is electrically connected in series with electrical contacts (not shown) within switch 40. Tool 20 has an electric power cord 52 which is connected to a conventional plug (not shown). As shown, gearbox 42 is a two speed gear reducer switchable by way of a slide operator 46. Operator 46 has a yoke or fork 70 interengaged with a groove 72 in a collar 74. Collar 74 is free to slide axially along a shaft 76, but is coupled to shaft 76 by a key 78 such that collar 74 will rotate with shaft 76. Collar 74 has a plurality of pins or projections 80 that extend longitudinally of collar 74 and selectively engage collar 74 with one of bevel gears 82 or 84. Each of gears 82 and 84 are journalled on shaft 76. When pins 80 are positioned as shown in FIG. 6, pins 80 are engaged with gear 82, causing an output drive member 86 to rotate at a first, higher speed, which preferably is about 3000 RPM. When slide operator 46 is moved to the right (as shown in FIG. 6), collar 74 disengages pins 80 from gear 82, and engages pins 80 with gear 84, causing drive member 86 to rotate at a second, lower speed, preferably about 1500 RPM.

Optionally, the right angle gear drive may have only a single speed, preferably about 3000 RPM. It is to be understood that each of gears 82 and 84 mesh with respective mating bevel gears 88 and 90, each of which are coupled in a driving relationship with output drive member 86. Output drive member 86 preferably has internal threads 92 to receive and mate with corresponding male threads 94 on mounting nut 31.

Motor 44 preferably has a splined output shaft 96 mating with a spur gear 98 affixed to shaft 76. Motor 44 may also have a fan 100 and preferably has a pair of bearings 102, 104 supporting the armature or rotor 106 of the motor 44 in the housing 36. Optionally, motor 44 may be a multiple speed or variable speed motor, if desired, used with a switching circuit or a conventional variable speed motor controller, if desired, to obtain the multiple speeds or variable speed.

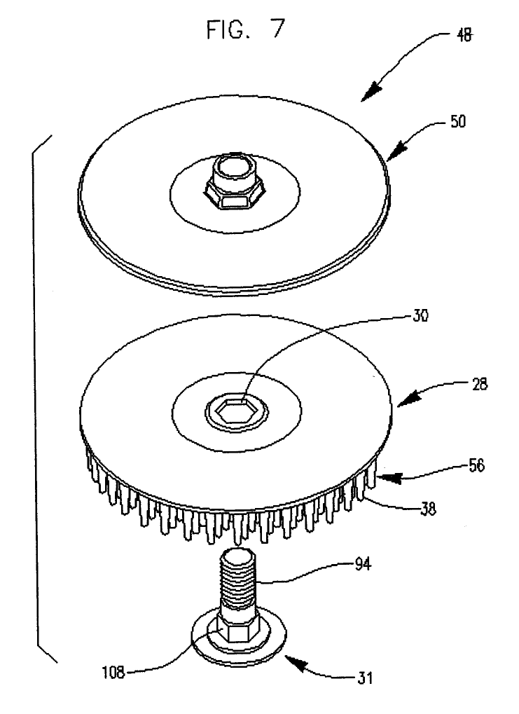

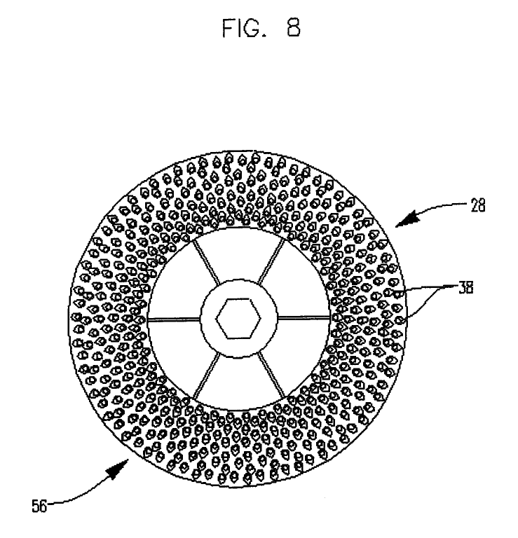

Referring now to FIGS. 6, 7, and 8, certain details of the abrasive disk 28 and associated parts in a disk assembly 48 may be seen. Assembly 48 preferably includes the disk 28, a backing plate 50 and the mounting nut 31. Disk 28 preferably has a plurality of elastomeric fingers 56 forming bristles 38, with abrasive particles embedded therein. The backing plate 50 is formed of relatively rigid material to support disk 28 and has a non-circular recess 54 to receive a non-circular shoulder 108 on nut 31. Nut 31 may have a recess 110 with a hexagonal cross section sized to receive a conventional Allen or hex wrench (not shown) for installation and removal of the disk assembly 48 from the output drive member 86. It is to be understood, however, that it is preferable to be able to install and remove the disk without the use of separate tools. In this aspect, the tool 20 may have a spring loaded locking pin, for example pin 34, biased by a spring 35 away from a member of the drive train (the drive train including the motor 44, the gear drive 42 and the output drive member 86), but selectively engageable with the member of the drive train to lock the drive train from rotation for installation and removal of the disk 28. In the arrangement shown, pin 34 is manually engageable with one or more recesses or apertures 39 in a web of bevel gear 90. Optionally, the pin 34 may be located elsewhere on the tool 20. Disk 28 has a mating aperture 30 conforming to the non-circular shoulder 108, to prevent disk 28 from turning with respect to output drive member 86, once installed thereon. As may be seen in FIGS. 7 and 8, the non-circular configuration for aperture 30 and shoulder 108 is preferably a hexagon, but may be any other non-circular configuration suitable to resist relative rotation of disk 28 with respect to nut 31 and output drive member 86.

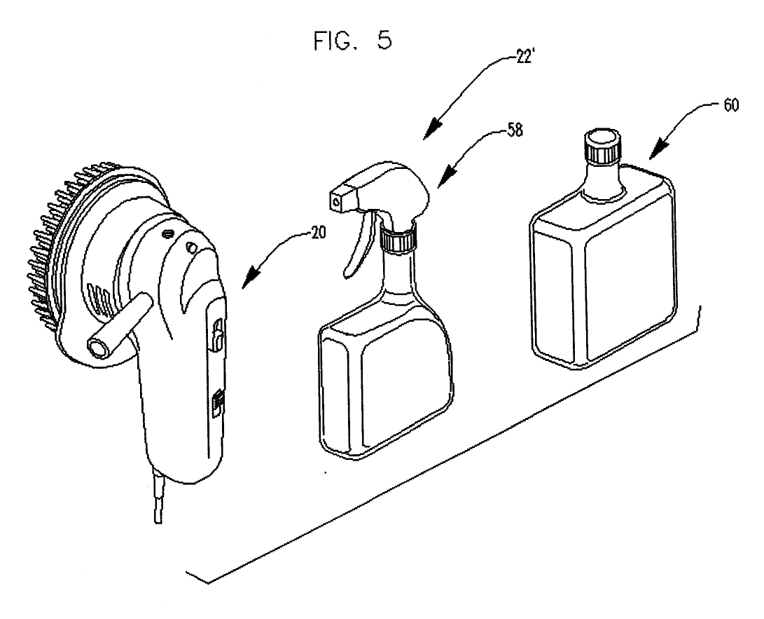

Referring now to FIG. 5, in an alternative embodiment 22′ of the kit, the paint softening chemical 26 may be supplied in a sprayable form, with a sprayer 58 and (optionally) a refill bottle 60 to replenish the sprayer with the chemical 26. Although one form of manually operated sprayer 58 is shown, it is to be understood that other forms of sprayers (or other applicators, such as rollers) may be found useful in the practice of the present invention.

The method of the present invention is directed to removing the chipped paint and provides a feathered transition between the substrate (which may be bare or may include substratum coatings below the outermost coating and which substratum coatings are well adhered to the substrate) and the remaining well-adhered (old outermost) paint on the substrate. The present invention is also directed to removing paint oxides which are apparent as a “chalky residue” on the previously painted surface. Finally, the present invention is directed to slightly abrading the surface, to provide “tooth” for improved adherence of a new paint coating to be applied after the practice of the present invention. As used herein, “tooth” refers to a slight surface texture created by abrasion in what would otherwise be a smooth non-porous surface.

In one embodiment, a single speed tool is provided. In an alternative embodiment, a multi speed tool may be provided, in which for one aspect, a high speed setting may be used for large open areas to be treated, and in another aspect, a low speed setting is available for trim, molding and more detailed or delicate surfaces to be treated.

The method of the present invention may include pre treating badly chipped and cracked surfaces by (optionally) mechanically removing the large, easy to remove paint chips from the surface to be treated. This may be accomplished using a putty knife or manual paint scraper. Next, the paint softening chemical is applied to the surface using a conventional paint brush or similar applicator. The paint softener is then allowed to act on the old paint, typically by waiting for about one hour. Next the powered tool is used to remove the paint oxides (chalky residue) from the surfaces having intact old paint. A pre-rinse with water may optionally be used at this time to act as a lubricant and to prolong the life of the bristle disk. One or two passes with the powered tool are used to remove the paint oxides. Next, the areas treated with the paint softening tool are re-wetted (if necessary), for example, using a garden hose. Wait about at least 3 minutes for the chemical to absorb the re-wetting water. The powered tool is then used to remove softened paint and to feather edges adjacent well adhered old paint, using 2 or 3 passes. Finally, the surface is washed down with water to remove any remaining softening chemical and debris from the previous surface preparation steps. After the surface is completely dry, it is ready to be repainted. It is to be understood that the present invention is directed to surfaces that have previously been coated with either latex or non-latex (e.g., oil-based) coatings.

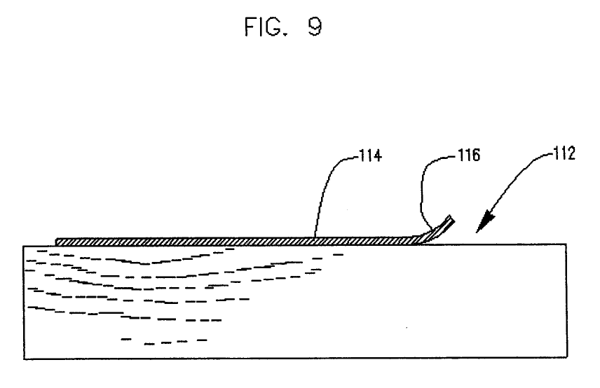

Referring now most particularly to FIGS. 9-12, a previously coated surface is shown (in a somewhat schematic fashion) before, during various stages of preparation according to the present invention, and as the surface appears after the practice of the present invention. FIG. 9 shows a section view of a surface or substrate 112 in need of repainting, with an old coating of paint 114 shown as it would be in a condition chipped and peeling from the surface 112. This view is intended to illustrate a typical condition of a weathered surface in need of repainting.

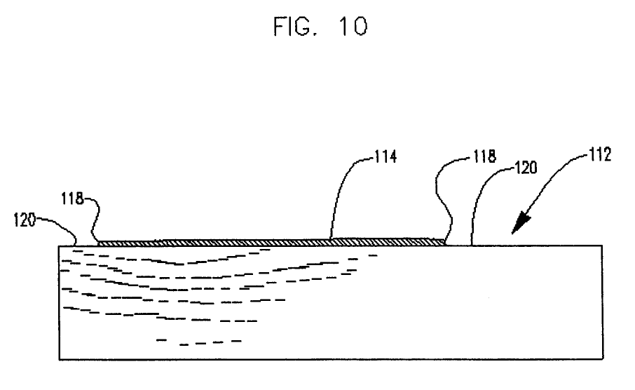

Referring now to FIG. 10, as a first step (preferable, but not essential) the loose paint 116 from the previous coating is mechanically removed using a putty knife, paint scraper, wire brush or other similar paint preparation tool. It is to be understood that this step may be performed similarly to the way such a step has been performed in the prior art, except that less care need be taken in the performance of this step in connection with the present invention, since later steps of the method of the present invention will further and completely prepare the surface whether this step is carried out with care. The method of the present invention may be carried out even with the complete omission of this step, however to obtain the full benefits of the present invention, mechanical removal of loose paint is preferred. Once the loose paint is removed mechanically, the surface 112 will appear as shown in FIG. 10, typically with some of the old coating 114 remaining, often with a step-like transition 118 between the remaining old coating and a bare or uncoated region 120 of substrate 112. Alternatively, one or more regions 120 may include well-adhered prior coatings (not shown) which were applied before coating 114. Such a step-like transition is undesirable since it often remains as a visible topographical feature, even when coated with a new coating. For this reason, in the prior art, it was known to mechanically fair such transitions, using conventional techniques such as sanding. Alternatively, it was known in the prior art to use a chemical paint stripper to remove some, most or all of the old coating 114. After use of a chemical paint stripper according to the prior art, it was sometimes still found necessary or desirable to sand the surface 112.

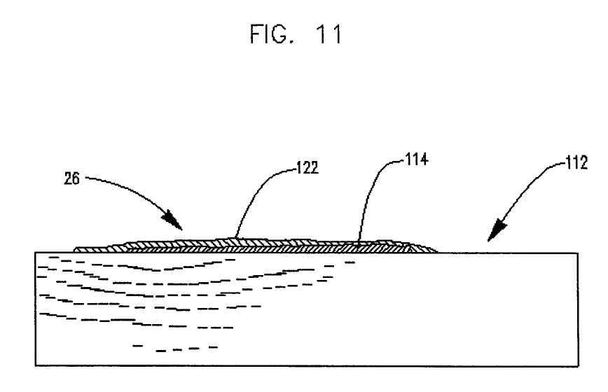

In the practice of the method of the present invention after the mechanical removal of loose paint, a coating 122 of the paint softening chemical 26 is applied as illustrated in FIG. 11, which is a view of the surface of FIG. 10, except after application of the paint softening chemical 26. The paint softening chemical 26 is preferably a BACK TO NATURE G-4-1, most nearly similar to a BACK TO NATURE II product, each of which are produced by Back to Nature Products Co., Division of Dynacraft Industries Inc., at 28 Harrison Ave., Suite 238, Englishtown, N.J. 07726. The paint softening chemical 28 is similar to the BTN II paint stripper, except that it is weaker and has a surfactant and lubricant added to improve operation with the tool 20 in the practice of the present invention. The Material Safety Data Sheet for the BACK TO NATURE G-4-1 product lists the following ingredients:

| | | |
|---|---|---|
| N.Methyl-2 Pyrrolidone | (872-50-4) | 15-30% |
| Dimethyl Glutarate | (1119-40-0) | 20-25% |
| Dimethyl Adipate | (627-93-0) | 10-15% |
| Non Hazardous components | | 50-65% |

The paint softening chemical 26, in a preferred form, is a gel-like substance which may be applied using the brush 24. In use, it is applied as shown in FIG. 11 and allowed to react with the old coating 114 for a predetermined period of time (a “softening dwell time”), typically about one half hour, it being understood that the material, condition and thickness of the old coating and the environmental conditions in which the present invention is practiced may indicate a different softening dwell time. Optionally, after the softening dwell time has elapsed, the surface may be wetted, to reactivate the chemical 26, and to provide additional lubrication at the surface 112 to be contacted by the disk 28 in the operation of the tool 20.

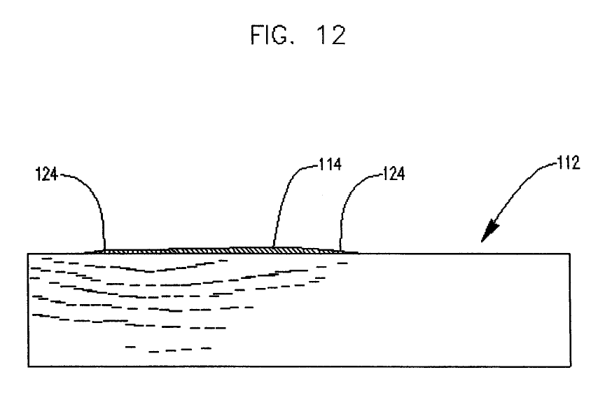

Once the softening dwell time has elapsed (and the surface rewetted, if desired, e.g., in hot, dry environmental conditions) tool 20 is manually grasped and urged against surface 112 to remove coating 122 and any oxide on old coating 114, and to feather each of the step like transitions 118 to a tapered transition 124, as shown in FIG. 12. Optionally, once the surface 112 has been abraded using tool 20, it may be rinsed, to remove any remaining chemical 26 and any loose debris.

After treatment according to the present invention, FIG. 12 illustrates a cross sectional view of the surface 112 ready for repainting, it being understood that the surface has been allowed to dry thoroughly before being ready for repainting.

This invention is not to be taken as limited to all of the details thereof as modifications and variations thereof may be made without departing from the spirit or scope of the invention.

What is claimed is:

1. A kit for preparing a previously coated surface for reapplication of a coating such as paint, the kit comprising:
a. a softening chemical for softening a perimeter of the old coating adjacent locations where the old coating has lifted away from the surface previously coated;
b. an applicator for applying the softening chemical;
c. a powered hand tool for removing oxides from the old coating and feathering the periphery softened by the softening chemical, the powered hand tool including;
i. an abrasive bristle disk having abrasive particles embedded in a plurality of elastomeric fingers generally perpendicularly from a disk-shaped support surface,
ii. means to rotate the bristle disk;
iii. a handle to manually grasp the powered hand tool using the hand of a user; and
iv. a peripheral guard surrounding a portion of the disk and located between the hand of the user grasping the handle and the abrasive disk.

2. The kit of claim 1 wherein the applicator is a brush.

3. The kit of claim 2 wherein the applicator is a sprayer.

4. The kit of claim 1 wherein the means to rotate the bristle disk comprises an electric motor.

5. The kit of claim 4 wherein the means to rotate the bristle disk further comprises a right angle drive.

6. The kit of claim 1 wherein the guard has a relief distal of the handle to permit observation of a portion of the disk during operation of the tool.

7. A method of preparing a previously coated surface for recoating, the method comprising the steps of:
a. applying a softening chemical to soften the edge regions of the coating remaining on the previously coated surface adjacent to where the coating has lifted away from the surface; and
b. abrading the previously coated surface with a rotating bristle disk of the type having a plurality of elastomeric fingers impregnated with an abrasive material to:
i. remove oxides and any remaining debris and dirt from the previously coated surface, and
ii. feather the edges softened by the softening chemical.

8. The method of claim 7 comprising an additional step before step a. of:
a0. mechanically removing loose coating from the previously coated surface.

9. The method of claim 7 comprising an additional step after step b. of:
c. rinsing the previously coated surface to remove debris and residue of the softening chemical.

10. The method of claim 7 comprising an additional step a1. between steps a. and b. of:
a1. waiting for at least a first predetermined time to allow the softening material to penetrate the previously applied coating.

11. The method of claim 10 comprising an additional step a2. between steps a1. and b. of:
a2. rewetting the areas with water where the softening chemical was applied in step a.

12. The method of claim 11 comprising an additional step a3. between steps a2. and b. of:
a3. waiting for at least a second predetermined time to allow the softening material to absorb the water from step a2.

13. The method of claim 7 wherein step b is performed substantially below conventional angle grinder speeds.

14. The method of claim 7 wherein step b is performed substantially below about 10,000 RPM.

15. The method of claim 7 wherein step b is performed at about 3000 RPM or below.
